(19) United States
(12) Patent Application Publication
(10) Pub. No.: US 2009/0299596 A1
(43) Pub. Date: Dec. 3, 2009

(54) Collision Avoidance Methods and Systems For Gravity Propelled Vehicles

(76) Inventors: Stig Albertsson, East Dorset, VT (US); William L. Smith, Shaftsbury, VT (US)

Correspondence Address: HESLIN ROTHENBERG FARLEY & MESITI PC, 5 COLUMBIA CIRCLE, ALBANY, NY, 12203, US

(21) Appl. No.: 12/472,552

(22) Filed: May 27, 2009

Related U.S. Application Data
(60) Provisional application No. 61/056,181, filed on May 27, 2008.

(51) Int. Cl. G08G 1/16; B60T 7/12; G01S 13/08; B60Q 1/00

(52) U.S. Cl. 701/70; 342/61; 342/118; 340/436

(57) ABSTRACT

A method for avoiding a likelihood of collision on a track disposed on a pitched terrain between an approaching gravity driven vehicle and a forward gravity driven vehicle includes activating a warning in the approaching vehicle for alerting the rider to manually slow down the approaching vehicle to increase a distance between the approaching vehicle and the forward vehicle, and automatically controlling application of a brake in the approaching vehicle to slow down the approaching vehicle to increase the distance between the approaching vehicle and the forward vehicle. For example, the approaching vehicle receives a first signal regarding a warning zone for activating the warning, and a second signal regarding a danger zone for automatically activating the brake. The method and systems may be employed on gravity driven vehicles for use on mountain or alpine coasters.

### CLAIM TO PRIORITY

This application claims the benefit of U.S. Provisional Application No. 61/056,181, filed May 27, 2008, entitled “Collision Avoidance Methods And Systems,” the entire subject matter of which is hereby incorporated herein by reference.

### FIELD OF THE INVENTION

This invention relates generally to collision avoidance methods and systems and, more particularly, to collision avoidance methods and systems for gravity propelled vehicles such as carts for alpine coasters or mountain coasters.

### BACKGROUND OF THE INVENTION

Alpine coasters or mountain coasters are generally a cross or between an alpine slide and a roller coaster and are becoming frequently installed at ski resorts. Mountain coasters typically include a stainless steel track supported directly on the mountain and carts that are held in place by the track. Mountain coasters may have a vertical drop of hundreds of feet and a track that extends thousands of feet long. The track typically includes a plurality of twists and turns along its length. The track may define a single course having a beginning end at an upper portion of the mountain and an ending at a lower portion of the mountain. The track may alternatively be configured in a continuous loop having means like a roller coaster for transporting the carts up the mountain wherein the carts descend upon cresting the top of the track.

Riders control the velocity of the carts in that they can choose not to brake and go fast similar to a roller coaster, or choose to break and go slower and take more of a scenic-type ride down the mountain. The carts can reach speeds of up to 25 miles per hour on the track.

Typically, the carts include manual brake levers disposed on both sides of the cart. The cart may also include a hydraulic speed restrictor, which can be set to restrict the cart from exceeding a certain speed. Other safety features include energy absorbent front and rear bumpers.

While the operators of the mountain coasters try to keep the riders a safe distance apart, e.g., about 80 feet, some riders traverse more slowly down the mountain than others allowing faster riders to catch up with the slower riders. As a result, accidents can happen when a rider going too fast crashes into a rider in front.

There is a need for collision avoidance systems and, more particularly, to collision avoidance systems for gravity propelled vehicles such as carts for use on alpine coasters or mountain coasters.

### SUMMARY OF THE INVENTION

The shortcomings of prior art carts for alpine coasters and mountain coasters are alleviated by employing collision avoidance systems in accordance with one or more aspects of the present invention.

In a first aspect, the present invention provides a method for avoiding a likelihood of collision on a track disposed on a pitched terrain between an approaching gravity driven vehicle on the track operated by a first rider traversing the track and a forward gravity driven vehicle on the track operated by a second rider traversing the track. The method includes activating a warning in the approaching gravity driven vehicle for alerting the first rider to manually slow down the approaching gravity driven vehicle to increase a distance between the approaching gravity driven vehicle on the track and the forward gravity driven vehicle on the track, and automatically applying a brake in the approaching gravity driven vehicle to slow down the approaching gravity driven vehicle to increase the distance between the approaching gravity driven vehicle on the track and the forward gravity driven vehicle on the track.

In a second aspect, the present invention provides a method for avoiding a likelihood of collision on a track disposed on a pitched terrain between an approaching gravity driven vehicle on the track operated by a first rider traversing the track and a forward gravity driven vehicle on the track operated by a second rider traversing the track. The method includes receiving in the approaching gravity driven vehicle a first signal indicative of the approaching gravity driven vehicle on the track entering a warning zone relative to the forward gravity driven vehicle on the track, activating a warning in the approaching gravity driven vehicle for alerting the first rider to manually slow down the approaching gravity driven vehicle on the track upon entering the warning zone, receiving in the approaching gravity driven vehicle a second signal indicative of the approaching gravity driven vehicle on the track entering a danger zone relative to the forward gravity driven vehicle on the track, and automatically applying a brake in the approaching gravity driven vehicle on the track to automatically slow down the approaching gravity driven vehicle on the track upon entering the danger zone.

In a third aspect, the present invention provides a system for avoiding a likelihood of collision on a track disposed on a pitched terrain between an approaching gravity driven vehicle on the track operated by a first rider traversing the track and a forward gravity driven vehicle on the track operated by a second rider traversing the track. The system includes a processor operable for controlling activation of a warning in the approaching gravity driven vehicle for alerting the first rider to manually slow down the approaching gravity driven vehicle to increase a distance between the approaching gravity driven vehicle on the track and the forward gravity driven vehicle on the track, and the processor being operable for automatically controlling application of a brake in the approaching gravity driven vehicle to slow down the approaching gravity driven vehicle to increase the distance between the approaching gravity driven vehicle on the track and the forward gravity driven vehicle on the track.

In a fourth aspect, the present invention provides a system for avoiding a likelihood of collision on a track disposed on a pitched terrain between an approaching gravity driven vehicle on the track operated by a first rider traversing the track and a forward gravity driven vehicle on the track operated by a second rider traversing the track. The system includes a receiver operable to receive in the approaching gravity driven vehicle a first signal indicative of the approaching gravity driven vehicle on the track entering a warning zone relative to the forward gravity driven vehicle on the track, and a second a second signal indicative of the approaching gravity driven vehicle on the track entering a danger zone relative to the forward gravity driven vehicle on the track. A processor is operable for controlling activation of a warning in the approaching gravity driven vehicle for alerting the first rider to manually slow down the approaching gravity driven vehicle on the track upon entering the warning zone, and the processor is operable for automatically controlling application of a brake in the approaching gravity driven vehicle on the track to automatically slow down the approaching gravity driven vehicle on the track upon entering the danger zone.

In a fifth aspect, the present invention provides a gravity driven vehicle operable by a rider. The gravity driven vehicle includes a chassis having a plurality of wheels and a braking system, and the collision avoidance system as noted above attached to the gravity driven vehicle.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a perspective view of a gravity driven vehicle employing the collision avoidance system in accordance with the principals of the present invention in which the gravity driven vehicle is disposed on a track of a mountain coaster;

FIG. 2 is generally a top perspective view of the gravity driven vehicle of FIG. 1 with the body of the gravity driven vehicle removed to illustrate the brakes;

FIG. 3 is another top perspective view of the gravity driven vehicle of FIG. 1 with the body of the gravity driven vehicle removed to illustrate the brakes;

FIG. 4 are side lavational views of two gravity driven vehicles of FIG. 1 employing the collision avoidance system in accordance with the principals of the present invention;

FIG. 5 is a diagrammatic illustration of the two gravity driven vehicles of FIG. 4 with the approaching gravity driven vehicle entering a warning zone;

FIG. 6 is a diagrammatic illustration of the two gravity driven vehicles of FIG. 4 with the approaching gravity driven vehicle entering a danger zone;

FIG. 7 is a graph of amplitude verses distance for the signal in determining a warning zone and a danger zone:

FIG. 8 is a diagrammatic illustration of one embodiment of a braking system for use in the collision avoidance system; and

FIG. 9 is a block diagram of one embodiment of a collision avoidance system in accordance with the principals of the present invention.

### DETAILED DESCRIPTION OF THE INVENTION

In one aspect, the present invention provides collision avoidance systems for gravity driven vehicles which may provide for more stable, safer, and enjoyable rides. For the purpose of convenience only, the collision avoidance system will be described in reference to alpine or mountain coasters for reducing the likelihood of rear end collisions, but it should be understood that the collision avoidance system can also be used on other gravity driven vehicles that require control of speed down high pitched terrain. Also, it is understood that the collision avoidance system of the present invention may also be applied to other vehicles such as automobiles.

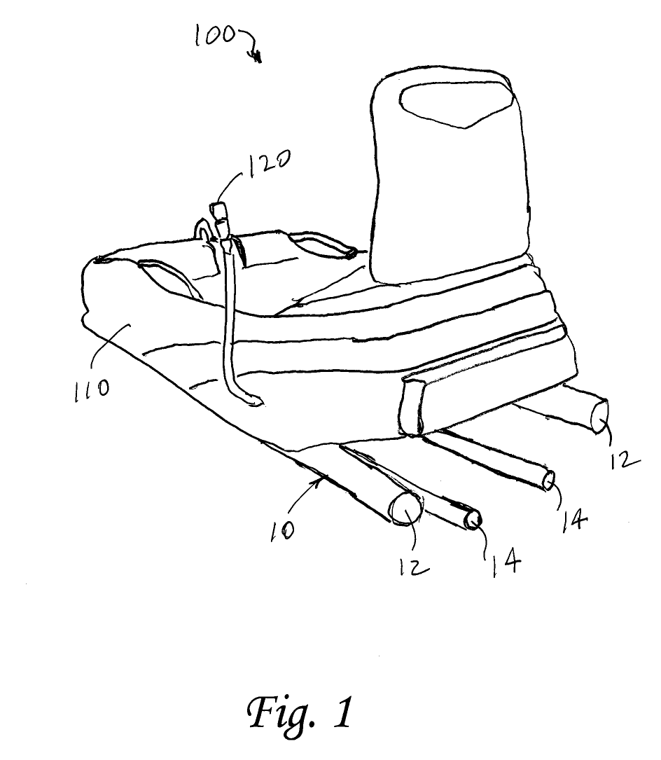

FIG. 1 illustrates one example of a cart or gravity driven vehicle 100 that can be adapted to incorporate a collision avoidance system constructed in accordance with one or more aspects of the present invention. Gravity driven vehicle 100 includes a body 110 for supporting a rider on a top side and brake control levers 120 (only one of which is shown in FIG. 1) that allow a rider to control the speed, acceleration, and braking of the gravity driven vehicle as the gravity driven vehicle traverses down the mountain.

As best shown in FIG. 1, a track 10 defines a rail system which may include a plurality of tubes. For example, the track may include two larger outer tubes 12 and two smaller inner tubes 14. The larger outer tubes may be about three inches in diameter and the smaller inner tubes may be about two inches in diameter. The wheels of the gravity driven vehicle ride on the larger outer tubes. The inner tubes are used for breaking and guiding the gravity driven vehicle.

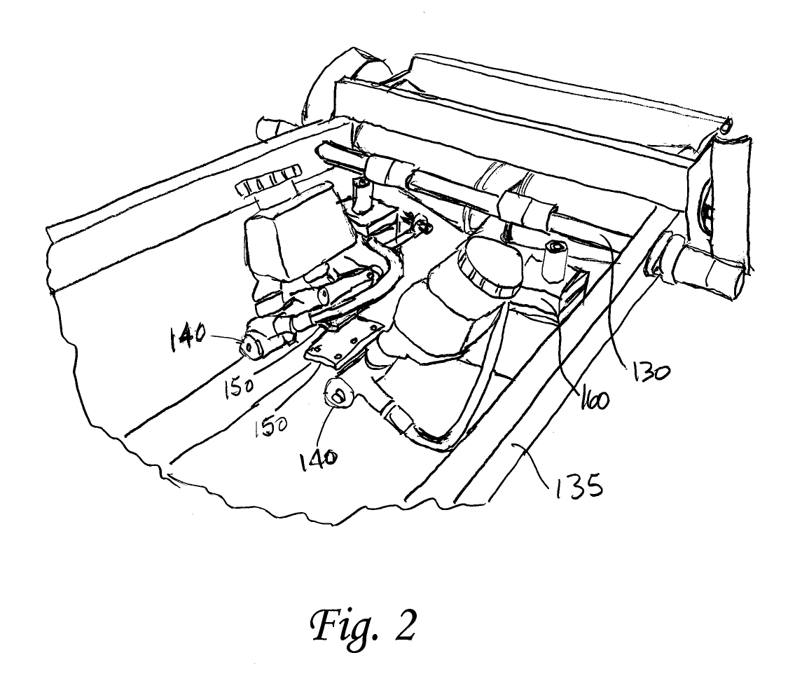

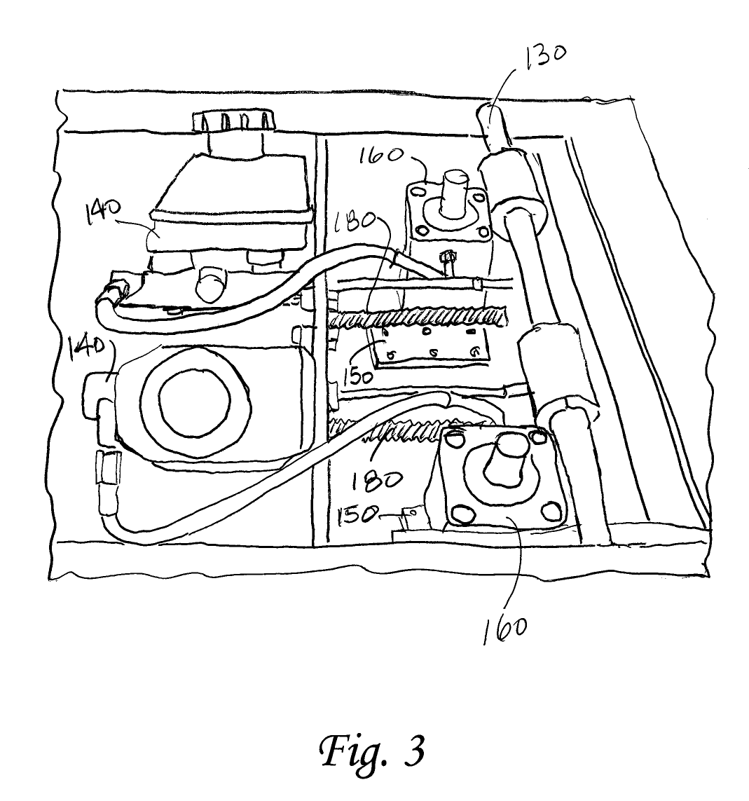

With reference to FIGS. 2 and 3, brake control levers 120 (FIG. 1) extend through body 100 (FIG. 1) which connect to a rod 130 operably attached to a chassis 135, to actuate master cylinders 140. Master cylinders operate hydraulic cylinders 160. Hydraulic cylinders clamp the brake rail with brake pads 150. The brake levers are held in the brake position by springs 180 (FIG. 3). To allow the gravity driven vehicle to travel, the rider pushes the brake levers forward to release the brake pads from the brake rail. In order to brake, the rider pulls the break levers in order that the brake pads clamp the brake rails.

The gravity driven vehicle may incorporate two rear axles. At the end of each axle is a wheel, which rides on top of one of the upper tubes. Each axle system may include one or more hydraulic speed restrictors (not shown) which limit the maximum speed of the gravity driven vehicle. The hydraulic speed restrictor may be operable to limit the rotational speed of the wheels. One such a restrictor is disclosed in U.S. patent application Ser. No. 11/267,347, entitled “Speed Control Mechanism” which published as U.S. Patent Application Publication No. 2006/0103095, the entire contents of which is incorporated herein by reference.

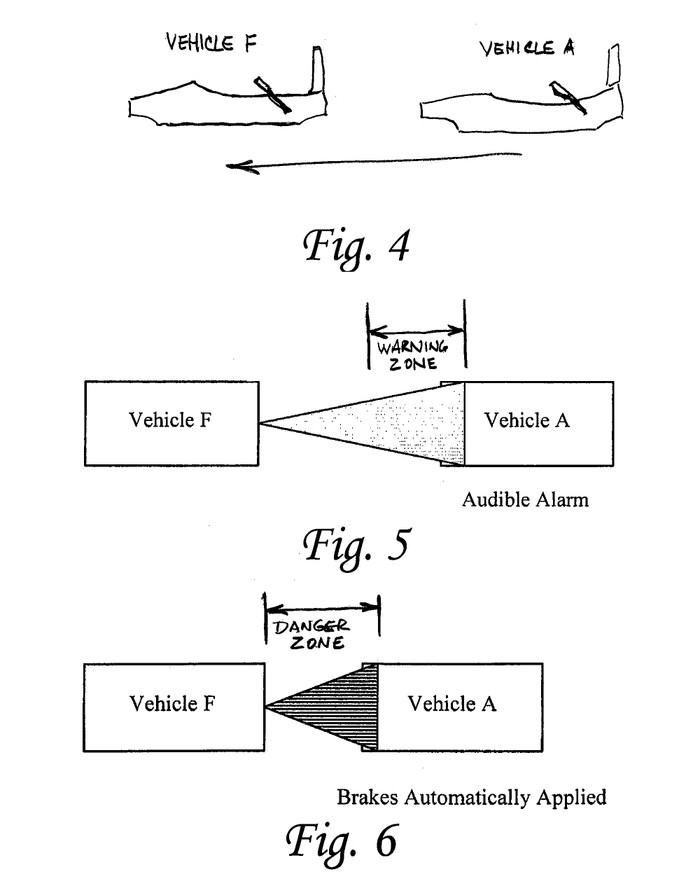

FIG. 4 illustrates two gravity driven vehicles employing the collision avoidance system in accordance with the principals of the present invention. For discussion, both gravity driven vehicles are moving along a track in the same direction, as indicted by the arrow, with the forward gravity driven vehicle labeled “Vehicle F” and the approaching gravity driven vehicle labeled “Vehicle A.”

The application of the brakes of the gravity driven vehicles are typically manually operated by the rider. However, as described in greater detail below, in the collision control system in accordance with the principals of the present invention, the brakes or a separate set of brakes may be automatically applied by the collision avoidance system. The braking system may include motors, hydraulic pumps, levers, and/or linear actuators. Automatic braking may be accomplished through valves, actuators, electro magnets, and/or solenoids.

Generally, the collision avoidance system monitors the distance between two gravity driven vehicles. When the approaching gravity driven vehicle enters a warning zone, as shown in FIG. 5, of being too close to the forward gravity driven vehicle, an audible alarm will sound and/or a warning lamp will light in the approaching gravity driven vehicle to alert the rider of the approaching gravity driven vehicle to manually slow down and increase the distance between the forward gravity driven vehicle, e.g., manually apply the brakes. If the rider does not sufficiently slow down the approaching gravity driven vehicle and enters a danger zone, as shown in FIG. 6, the braking system is turned on for the approaching gravity driven vehicle to ensure braking is being applied. Once the distance between the gravity driven vehicles is greater than the danger zone and/or the warning zone, the braking system will be released and braking will be under the control of the rider of the approaching gravity driven vehicle once again and/or other systems.

For example, with reference again to FIG. 5, the forward Vehicle F may transmit a signal such as a pulsating infrared signal from the rear of the forward gravity driven vehicle in a cone shaped pattern. The approaching Vehicle A has a receiver such as an infrared receiver in the front of the gravity driven vehicle. As the signal in approaching Vehicle A reaches a warning zone level, an audible alarm sounds warning the rider in approaching Vehicle A to manually apply the brakes.

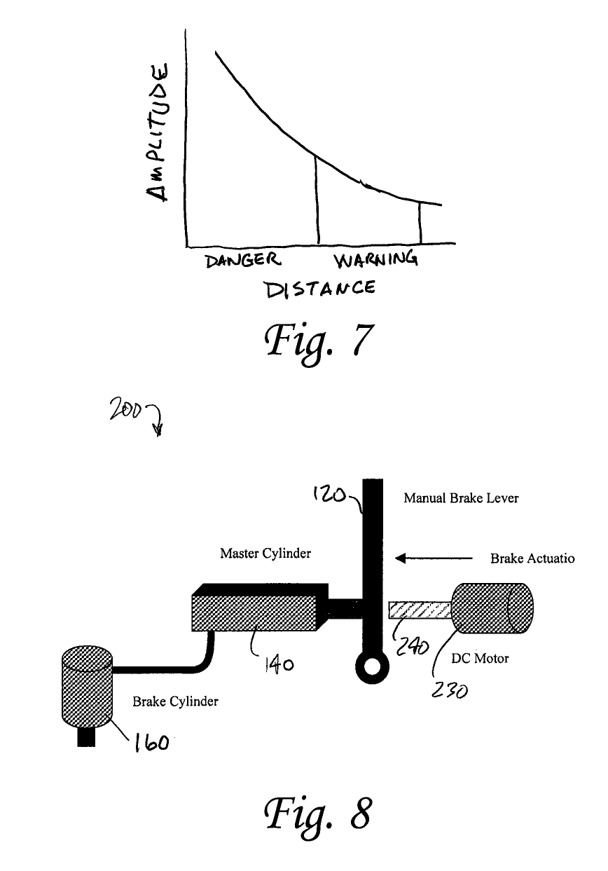

With reference again to FIG. 6, if the distance between forward Vehicle F and approaching Vehicle A decreases to a danger zone distance, the brakes in approaching vehicle A will be automatically applied. For example, when the amplitude of the received signal is at a predetermined level indicating the danger zone, the collision avoidance system will automatically apply the brakes in Vehicle A. When the distance between the gravity driven vehicles is greater than the danger zone distance and/or the warning zone distance, as shown in FIG. 5, the brakes will be automatically released and braking is then manually controllable by the rider. FIG. 7 is a graph of the amplitude verses the distance for the signal in determining the warning zone and the danger zone for use in accordance with the present invention.

In one embodiment, as shown in FIG. 8, a braking system 200 may include a manually operated master cylinder 140 operating a hydraulic cylinder 160. In the event of approaching Vehicle A entering the danger zone, the brakes are applied, for example, using a DC motor 230 moving a linear actuator 240 to apply a force on one of the manual brake control levers 120. The braking system may be installed under the gravity driven vehicle and operable to automatically operate the brakes.

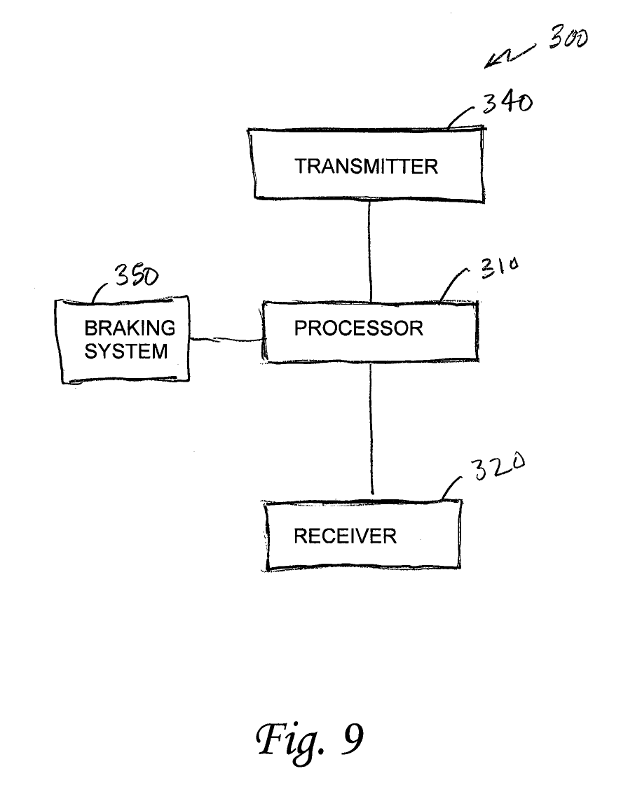

FIG. 9 is a diagrammatic illustration of a collision avoidance system 300. In this embodiment, collision avoidance system 300 may include a processor or micro-controller 310, a receiver 320, a transmitter 340, and a braking system 350. A suitable processor is PIC 16C745 available from Micro Chip, a suitable transmitter is PZ-G52BT available from Keyence, and a suitable receiver is PZ-G52BR available from Keyence.

In other embodiments of the present invention, the distance monitoring may be measured by transmitting a signal from the rear gravity driven vehicle and reflecting the signal from the front gravity driven vehicle. Distance may be measured by a function of amplitude or the time it take for the signal to return. A vision system may also be employed wherein the size of the observed forward gravity driven vehicle may be used to determine distance or a warning or danger zones.

The distance may also be monitored by external distance monitors. For example, the position of the gravity driven vehicles may be monitored by sensors that are not attached to the gravity driven vehicles. For example, sensors/transmitters may be employed in the track or along side the track for monitoring the locations of the gravity driven vehicles on the track. When a gravity driven vehicle is determined to enter a warning zone and or a danger zone, a signal can be transmitter to the approaching gravity driven vehicle to warn the rider to manually brake and/or automatically control braking of the gravity driven vehicle. The distance can be monitored by encoders or other position tracking devices.

Although the invention has been particularly shown and described with reference to certain preferred embodiments, it will be readily appreciated by those of ordinary skill in the art that various changes and modifications may be made therein, without departing from the spirit and scope of the invention.

1. A method for avoiding a likelihood of collision on a track disposed on a pitched terrain between an approaching gravity driven vehicle on the track operated by a first rider traversing the track and a forward gravity driven vehicle on the track operated by a second rider traversing the track, the method comprising:
activating a warning in the approaching gravity driven vehicle for alerting the first rider to manually slow down the approaching gravity driven vehicle to increase a distance between the approaching gravity driven vehicle on the track and the forward gravity driven vehicle on the track; and
automatically applying a brake in the approaching gravity driven vehicle to slow down the approaching gravity driven vehicle to increase the distance between the approaching gravity driven vehicle on the track and the forward gravity driven vehicle on the track.

2. The method of claim 1 wherein the activating the warning comprises activating the warning upon the approaching gravity driven vehicle on the track and the forward gravity driven vehicle on the track being a first distance apart, and wherein the automatically applying the brake comprises automatically applying the brake upon the approaching gravity driven vehicle on the track and the forward gravity driven vehicle on the track being a second distance apart, and wherein the second distance being less than the first distance.

3. The method of claim 2 further comprising deactivating the warning in the approaching gravity driven vehicle upon the approaching gravity driven vehicle returning to a distance between the approaching gravity driven vehicle on the track and the forward approaching gravity driven vehicle on the track being greater than the first distance, and automatically releasing the brake of the approaching gravity driven vehicle upon the approaching gravity driven vehicle returning to a distance between the approaching gravity driven vehicle on the track and the forward approaching gravity driven vehicle on the track being greater than the second distance.

4. The method of claim 1 wherein the activating the warning comprises activating the warning upon the approaching gravity driven vehicle entering a warning zone relative to the forward gravity driven vehicle, and wherein automatically applying the brake comprises automatically applying the brake upon the approaching gravity driven vehicle entering danger zone relative to the forward gravity driven vehicle, the danger zone being closer to the forward gravity driven vehicle than the warning zone.

5. The method of claim 4 further comprising deactivating the warning in the approaching gravity driven vehicle upon the approaching gravity driven vehicle exiting the warning zone, and automatically releasing the brake of the approaching gravity driven vehicle upon the approaching gravity driven vehicle exiting the danger zone.

6. A method for avoiding a likelihood of collision on a track disposed on a pitched terrain between an approaching gravity driven vehicle on the track operated by a first rider traversing the track and a forward gravity driven vehicle on the track operated by a second rider traversing the track, the method comprising:
receiving in the approaching gravity driven vehicle a first signal indicative of the approaching gravity driven vehicle on the track entering a warning zone relative to the forward gravity driven vehicle on the track;
activating a warning in the approaching gravity driven vehicle for alerting the first rider to manually slow down the approaching gravity driven vehicle on the track upon entering the warning zone;
receiving in the approaching gravity driven vehicle a second signal indicative of the approaching gravity driven vehicle on the track entering a danger zone relative to the forward gravity driven vehicle on the track; and
automatically applying a brake in the approaching gravity driven vehicle on the track to automatically slow down the approaching gravity driven vehicle on the track upon entering the danger zone.

7. The method of claim 6 further comprising deactivating the warning in the approaching gravity driven vehicle upon the approaching gravity driven vehicle exiting the warning zone.

8. The method of claim 6 further comprising automatically releasing the brake of the approaching gravity driven vehicle upon the approaching gravity driven vehicle exiting the danger zone.

9. The method of claim 6 wherein the warning zone comprises a first range of distances between the approaching gravity driven vehicle on the track and the forward gravity driven vehicle on the track, the danger zone comprises a second range of distances between the approaching gravity driven vehicle on the track and the forward gravity driven vehicle on the track, and the first range of distances being greater than the second range of distances.

10. The method of claim 6 wherein the first and the second signals comprise signals transmitted from the forward gravity driven vehicle.

11. The method of claim 6 wherein the first and the second signals comprises a signals transmitted from the approaching gravity driven vehicle.

12. The method of claim 11 wherein the first and the second signals comprise reflected signals.

13. The method of claim 6 further comprising comparing the first signal to a first predetermined value to determine the approaching gravity driven vehicle entering the warning zone, and comparing the second signal to a second predetermined value to determine the approaching gravity driven vehicle entering the danger zone.

14. The method of claim 6 wherein the warning comprises at least one of a warning light visible to the first rider of the approaching gravity driven vehicle and a sound audible by the first rider of the approaching gravity driven vehicle.

15. The method of claim 6 wherein the first and second signals comprise pulsing laser signals.

16. The method of claim 6 wherein the signal indicative of the approaching gravity driven vehicle entering a warning zone and the signal indicative of the approaching gravity driven vehicle entering a danger zone are based on an amplitude of the signals.

17. The method of claim 6 wherein the first and second signals comprise signals generated from at least one transmitter not located in the approaching gravity driven vehicle and the forward gravity driven vehicle.

18. The method of claim 17 wherein the at least one transmitter is located adjacent to the track traversed by the approaching gravity driven vehicle and the forward gravity driven vehicle.

19. A system for avoiding a likelihood of collision on a track disposed on a pitched terrain between an approaching gravity driven vehicle on the track operated by a first rider traversing the track and a forward gravity driven vehicle on the track operated by a second rider traversing the track, said system comprising:
a processor operable for controlling activation of a warning in the approaching gravity driven vehicle for alerting the first rider to manually slow down the approaching gravity driven vehicle to increase a distance between the approaching gravity driven vehicle on the track and the forward gravity driven vehicle on the track; and
said processor operable for automatically controlling application of a brake in the approaching gravity driven vehicle to slow down the approaching gravity driven vehicle to increase the distance between the approaching gravity driven vehicle on the track and the forward gravity driven vehicle on the track.

20. The system of claim 19 wherein said processor is operable to control activation of the warning based on the approaching gravity driven vehicle on the track and the forward gravity driven vehicle on the track being a first distance apart, and wherein said processor is operable to automatically control application of the brake based on the approaching gravity driven vehicle on the track and the forward gravity driven vehicle on the track being a second distance apart, and wherein the second distance being less than the first distance.

21. The system of claim 20 wherein said processor is operable to deactivate the warning in the approaching gravity driven vehicle upon the approaching gravity driven vehicle returning to a distance between the approaching gravity driven vehicle on the track and the forward approaching gravity driven vehicle on the track being greater than the first distance, and operable to automatically release the brake of the approaching gravity driven vehicle upon the approaching the gravity driven vehicle returning to a distance between approaching gravity driven vehicle on the track and the forward approaching gravity driven vehicle on the track being greater than the second distance.

22. The system of claim 19 wherein said processor is operable to activate the warning based on the approaching gravity driven vehicle entering a warning zone relative to the forward gravity driven vehicle, and wherein said processor is operable to automatically control application of the brake based on the approaching gravity driven vehicle entering danger zone relative to the forward gravity driven vehicle, the danger zone being closer to the forward gravity driven vehicle than the warning zone.

23. The system of claim 22 wherein said processor is operable to deactivate the warning in the approaching gravity driven vehicle upon the approaching gravity driven vehicle exiting the warning zone, and operable to automatically release the brake of the approaching gravity driven vehicle upon the approaching gravity driven vehicle exiting the danger zone.

24. A system for avoiding a likelihood of collision on a track disposed on a pitched terrain between an approaching gravity driven vehicle on the track operated by a first rider traversing the track and a forward gravity driven vehicle on the track operated by a second rider traversing the track, said system comprising:
a receiver operable to receive in the approaching gravity driven vehicle a first signal indicative of the approaching gravity driven vehicle on the track entering a warning zone relative to the forward gravity driven vehicle on the track, and a second a second signal indicative of the approaching gravity driven vehicle on the track entering a danger zone relative to the forward gravity driven vehicle on the track;
a processor operable for controlling activation of a warning in the approaching gravity driven vehicle for alerting the first rider to manually slow down the approaching gravity driven vehicle on the track upon entering the warning zone; and
said processor operable for automatically controlling application of a brake in the approaching gravity driven vehicle on the track to automatically slow down the approaching gravity driven vehicle on the track upon entering the danger zone.

25. The system of claim 24 wherein said processor is operable to control deactivation of the warning in the approaching gravity driven vehicle upon the approaching gravity driven vehicle exiting the warning zone.

26. The system of claim 24 wherein said processor is operable to automatically control release of the brake of the approaching gravity driven vehicle upon the approaching gravity driven vehicle exiting the danger zone.

27. The system of claim 24 wherein the warning zone comprises a first range of distances between the approaching gravity driven vehicle on the track and the forward gravity driven vehicle on the track, the danger zone comprises a second range of distances between the approaching gravity driven vehicle on the track and the forward gravity driven vehicle on the track, and the first range of distances being greater than the second range of distances.

28. The system of claim 24 further comprising a transmitter positioned on the forward gravity driven vehicle for transmitting signals toward the approaching driven vehicle.

29. The system of claim 24 further comprising a transmitter positioned on the approaching gravity driven vehicle for transmitting signals toward the forward gravity driven vehicle, and wherein the first and the second signals comprise reflected signals.

30. The system of claim 24 wherein said processor is operable to compare the first signal to a first predetermined value to determine the approaching gravity driven vehicle entering the warning zone, and operable to compare the second signal to a second predetermined value to determine the approaching gravity driven vehicle entering the danger zone.

31. The system of claim 24 further comprising a warning light visible to the first rider of the approaching gravity driven vehicle.

32. The system of claim 24 further comprising a speaker for generating a sound audible by the first rider of the approaching gravity driven vehicle.

33. The system of claim 24 wherein said receiver comprises a receiver operable to received pulsing laser signals.

34. The system of claim 24 wherein said processor is operable to determine the approaching gravity driven entering the warning zone and the approaching gravity driven vehicle entering a danger zone based on an amplitude of the signals.

35. The system of claim 24 wherein the at least one transmitter is located adjacent to the track traversed by the approaching gravity driven vehicle and the forward gravity driven vehicle.

36. The system of claim 24 further comprising means for automatically actuating the brake.

37. The system of claim 24 wherein said means for actuating the brake comprises a motor and an actuator.

38. A gravity driven vehicle operable by a rider, the gravity driven vehicle comprising:
a chassis having a plurality of wheels and a braking system; and
the collision avoidance system of claim 19 attached to the gravity driven vehicle.

39. A gravity driven vehicle operable by a rider, the gravity driven vehicle comprising:
a chassis having a plurality of wheels and a braking system; and
the collision avoidance system of claim 24 attached to the gravity driven vehicle.
